(19) United States
(12) Patent Application Publication
(10) Pub. No.: US 2009/0100743 A1
(43) Pub. Date: Apr. 23, 2009

(54) Device for Illumination and Insect Extermination

(76) Inventor: Adrian Prater, Richmond Hill (CA)

Correspondence Address: ADE & COMPANY INC., 2157 Henderson Highway, WINNIPEG, MB, R2G1P9, CA

(21) Appl. No.: 11/556,549

(22) Filed: Nov. 3, 2006

Related U.S. Application Data
(60) Provisional application No. 60/733,196, filed on Nov. 4, 2005.

(51) Int. Cl. A01M 1/22; A01M 1/04

(52) U.S. Cl. 43/112; 43/113

(57) ABSTRACT

A device for illumination and insect extermination for use with a conventional electrical wall outlet features a light source and an electrocution grid both operatively connected to electrical connectors through which power is supplied. The light source and grid are arranged such that the grid does not interfere with the transmission of light in at least one direction. A housing and a perforated translucent guard positioned about the light source and grid allow a substantial portion of the light emitted to leave the device while preventing accidental human contact with the electrocution grid. A switch allows the grid to be manually disabled while removal of the guard causes automatic disabling. A photoelectric sensor prevents wasteful energy use by activating the light source only when the surrounding environment is substantially dark.

This application claims the benefit under 35 U.S.C. 119(e) of U.S. provisional application Ser. No. 60/733,196, filed Nov. 4, 2005.

### FIELD OF THE INVENTION

This invention relates to an insect trap, and more particularly to an insect trap having a light source used to attract insects.

### BACKGROUND OF THE INVENTION

It is often desirable to set out insect traps to either kill or restrain insects that have invaded human occupied territory, especially within the home. A number of devices have been developed that attract insects to such traps by means of electrically produced light.

U.S. Pat. Nos. 1,962,420 and 4,951,414 both disclose insect electrocuting devices having high voltages applied across spaced apart electrodes such that insects that make their way between the electrodes act as a pathway for electricity to travel through to complete a circuit. In each case, the insects are attracted to this electrocution grid by a light source around which the grid is disposed. These devices feature screw caps for reception in a standard light socket to provide electricity to power both the light source and the grid. This feature limits where these devices can be placed and the wraparound arrangement of the grid about the light source interferes with light emitted therefrom, making the devices suitable for killing insects but not for doubling as a useful light source.

U.S. Pat. No. 4,212,129 discloses an insect trap that uses a tubular body with at least one end funnel through which insects can enter the body. An electric lamp mounted on a prong connector for a household electrical outlet is mounted inside the tubular body to attract insects therein. The substantially closed arrangement of the trap does not allow enough light to escape the body to add a useful secondary illuminating function to the primary insect trapping function.

U.S. Pat. Nos. 5,044,112 and 5,142,815 disclose insect traps for use with a conventional night light received in a wall mounted electrical socket. In each case, the night light is used to attract insects with the intention of retaining them on a tacky landing surface. The traps leave the insects alive and in plain view and tend to be quite bulky. An alternative embodiment presented in U.S. Pat. No. 5,044,112 discloses a more space efficient arrangement, but the tacky surface surrounding the light still traps the insects in plain view. Furthermore, as the number of insects trapped on the tacky surface builds up, the light source becomes more obscured.

U.S. Pat. No. Design 357,725 shows a flea trap with a pronged light source that that attracts fleas and supports the trap on an electrical outlet. Again, the invention does not kill the pests and uses a tacky surface to trap the insects in plain view, which leads to an unpleasant appearance. Furthermore, the light source is significantly obstructed, making the device unsuitable as an illumination source.

As a result, there is a desire for a compact device that can function as both an insect exterminator and a reliable illumination source without the need for external light sockets.

### SUMMARY OF THE INVENTION

According to a first aspect of the invention there is provided a device for illumination and insect extermination for use with a conventional electrical wall outlet, said device comprising:

a housing;

electrical connectors extending outward from the housing and adapted to mate with the conventional electrical wall outlet;

a light source supported on the housing and operatively connected to the electrical connectors; and

an insect electrocution grid supported on the housing and operatively connected to the electrical connectors.

The present invention overcomes the shortfalls of existing insect traps using a light source to attract insects. The electrocution grid operates to kill the insects rather than merely retain them, therefore there is no need to substantially enclose the attractive light source and restrict the transmission of light therefrom. Furthermore, the electrical connectors allow use of the device in any place near a conventional electrical wall outlet.

Preferably the insect electrocution grid is disposed between the electrical connectors and the light source in a horizontal direction.

Preferably the insect electrocution grid is disposed in a generally vertical plane, the electrical connectors and the light source being on opposite sides of said vertical plane.

Preferably the insect electrocution grid is arranged to leave at least one side of the light source open so as not to interfere with transmission of the light to said at least one side.

By ensuring that a path of light is left unobstructed by the grid, the device is more effective at serving as an illumination source as well as an insect exterminator.

Preferably there is provided a switch connected between the electrical connectors and the light source for selectively preventing and allowing transmission of the power from said electrical connectors to said light source. Preferably the switch is a photoelectric sensor for preventing and allowing transmission of the power to the light source during light and dark states respectively of an environment surrounding the device.

Preferably there is provided a switch connected between the electrical connectors and the insect electrocution grid for selectively preventing and allowing transmission of power from said electrical connectors to said grid. Preferably the switch is independent of the light source such that the transmission of power to said grid can be prevented without preventing transmission of power to said light source.

There may be provided a transformer connected between the electrical connectors and the insect electrocution grid to change a voltage of power supplied from said electrical connectors to said grid.

Preferably there is provided a guard detachably mounted on the housing for restricting access to the insect electrocution grid wherein the guard is perforated to allow the insects to pass therethrough while preventing access by larger bodies. Preferably the guard comprises a catching portion disposed beneath said electrocution grid to catch insects having been electrocuted thereby. Preferably the catching portion of the guard comprises a receptacle being open at a top end and closed at a bottom end and sides.

Preferably there is provided a switch connected between the electrical connectors and the insect electrocution grid for selectively preventing and allowing transmission of power from said electrical connectors to said grid, said switch being disposed between the guard and the housing such that mounting said guard on said housing actuates said switch to allow said transmission of power.

In the case where a guard is not provided, preferably there is provided a catching element supported on the housing beneath the electrocution grid to catch insects having been electrocuted thereby. In this case, preferably the catching element comprises a receptacle being open at a top end and closed at a bottom end and sides.

Preferably the light source comprises a bulb socket operatively connected to the electrical connectors and a bulb removably received in said bulb socket.

Preferably the insect electrocution grid comprises two arrays of electrodes for receiving opposing electrical charges from the electrical connectors, a distance between electrodes of one of the arrays and electrodes of the other array preventing power supplied through said connectors from flowing between said arrays unless said distance is substantially filled by a body separate from said device.

Preferably the electrical connectors comprise a pair of prongs from which the light source and insect electrocuting grid commonly receive power, said prongs extending outward from the housing for insertion into the conventional electrical wall outlet.

Preferably the housing comprises a mounting portion from which the electrical connectors extend, said mounting portion adapted to sit generally flush against the conventional electrical wall outlet with which said connectors are adapted to mate, the light source and insect electrocution grid supported on a side of the mounting portion opposite said connectors.

Preferably the housing further comprises a protruding portion extending to the side of the mounting portion opposite the electrical connectors, the light source being supported by said protruding portion.

### BRIEF DESCRIPTION OF THE DRAWINGS

In the accompanying drawings, which illustrate an exemplary embodiment of the present invention:

FIG. 1 is a front view of a device for illumination and insect extermination.

FIG. 2 is a side view of the device for illumination and insect extermination.

FIG. 3 is a bottom view of the device for illumination and insect extermination.

FIG. 4 is a front view of the device for illumination and insect extermination with a guard removed.

FIG. 5 is a side view of the device for illumination and insect extermination with the guard removed.

FIG. 6 is a bottom view of the device for illumination and insect extermination with the guard removed.

FIG. 7 is a front view of the guard of the device for illumination and insect extermination.

FIG. 8 is a side view of the guard of the device for illumination and insect extermination.

FIG. 9 is a top view of the guard of the device for illumination and insect extermination.

FIG. 10 is a cross sectional view of the guard of the device for illumination and insect extermination taken along the line 10-10 of FIG. 7.

### DETAILED DESCRIPTION

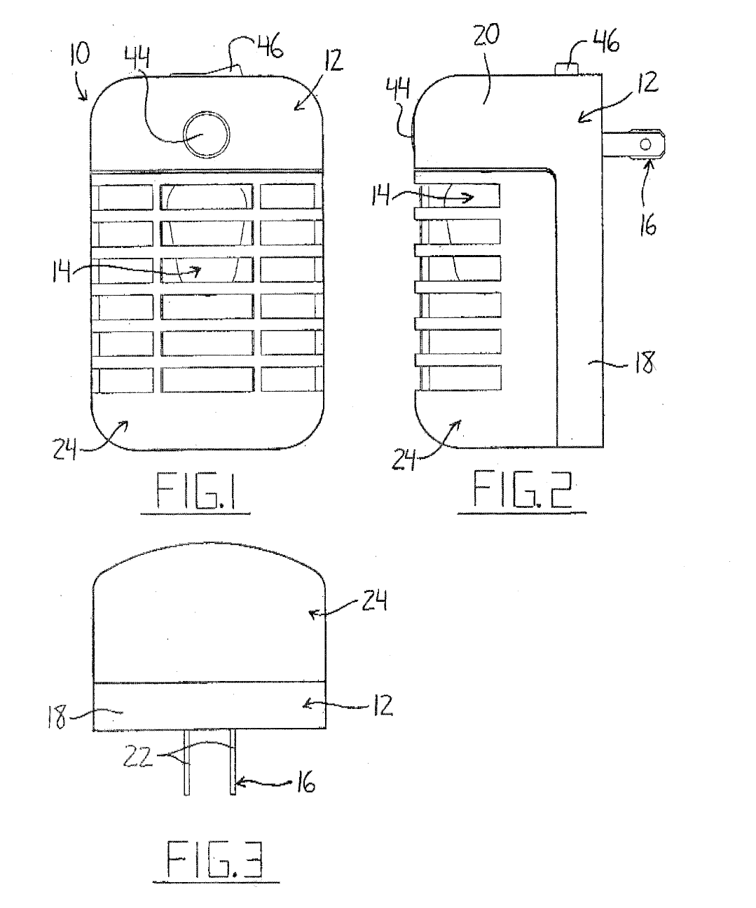

FIGS. 1 to 3 illustrate a fully assembled device for illumination and insect extermination according to the present invention. The device 10 used for both the extermination of insects and the illumination of darkened areas is shown having a construction designed for mounting in a generally flush arrangement with a typical household electrical wall outlet. The device 10 includes a housing 12 that supports a light source 14 and electrical connectors 16. The housing features a vertically extending mounting portion 18 that sits flush against a wall when a pair of prongs 22 forming the electrical connectors 16 extending rearward from the mounting portion 18 are inserted into a wall mounted electrical outlet to provide power to the device 10 and support it on the wall. A protruding portion 20 extending horizontally outward from the mounting portion 18 in a direction opposite the prongs 22 supports the light source 14. A guard 24 is detachably mounted on the housing 12 beneath the protruding portion 20 and directly in front of the mounting portion 18 to prevent accidental contact with an electrical bug zapping assembly behind it.

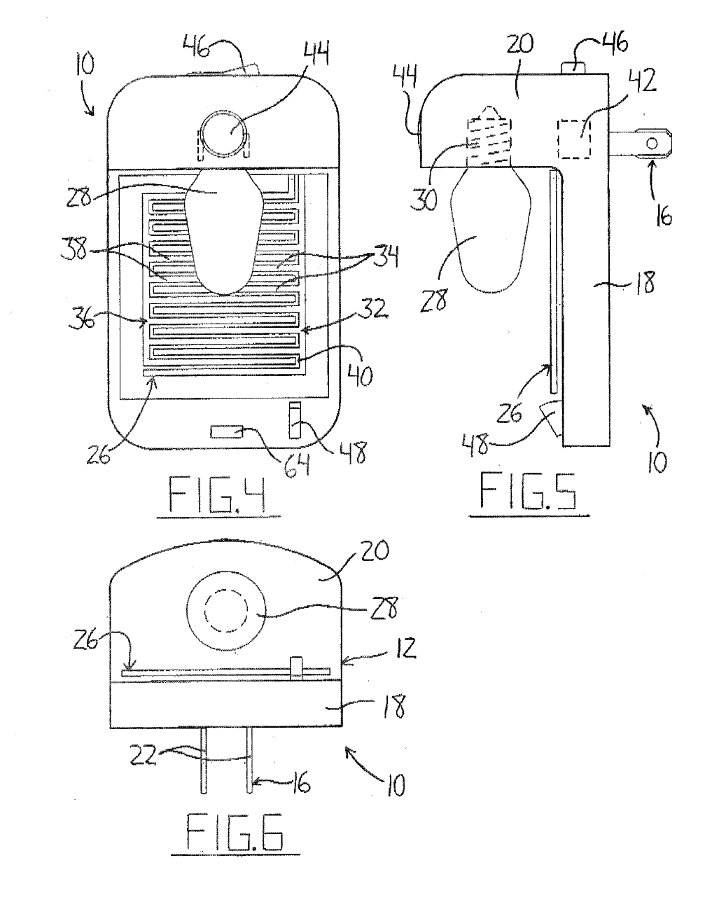

FIGS. 4 to 6 illustrate the device 10 having the guard 24 removed to show an insect electrocution grid 26 supported in a vertical plane in front of the mounting portion 18 of the housing 12. The light source 14 includes a conventional removable bulb 28 that can be easily screwed into and out of a light socket 30 provided in the protrusion portion 20 of the housing 12. In this arrangement, the socket 30 opens downward so that the bulb extends downward from the protrusion portion 20 and can be easily replaced with the guard 24 removed. As seen in the Figures, the grid 26 extends downward from the protrusion portion 20 of the housing between the bulb 28 and the mounting portion 18. In this arrangement, the grid 26 doesn't interfere light emitted by the bulb 28 in forward or transverse directions. In other words, light is only impeded by the grid 26 in a direction toward the mounting portion 18 and prongs 22, which sit against a wall when the device 10 is plugged into an electrical outlet anyway. As such, light from the bulb 28 is generally unobstructed and thus can serve to both attract insects to the electrocution grid 26 and provide a substantial source of light for use as a night light.

The insect electrocution grid 26 features a first array 32 of electrodes 34 and a second array 34 of electrodes 36, each array being operatively connected to one of the prongs 16. Each electrode 34 of the first array 32 is spaced from a respective electrode 38 of the second array 36 by a distance 40. This distance, or space, 40 creates an open circuit between the prongs 16 through which power is supplied from the electrical outlet such that current cannot flow between the arrays 32 and 36, creating opposite charges in the arrays of electrodes. When an insect attracted to light provided by the bulb 28 contacts an electrode 34 of the first array 32 and an electrode 38 of the second array 36 at the same time, it completes the circuit, causing current to flow through it. A voltage difference across the arrays 32 and 36 is high enough such that the electrocution kills the insect. Depending on the magnitude of the distance 40 between the electrodes of the separate arrays and the voltage difference therebetween, an insect may also be electrocuted when disposed between the electrodes but not necessarily making contact with both. For this to take place, the voltage difference must be high enough to cause the electric current to arc over open space left between the electrodes. It should be appreciated that the larger the space between electrodes, the higher the voltage difference must be to achieve these results.

Depending on the voltage necessary to operate the electrocution grid 26, a transformer 42 may be connected between the electrical connectors 16 and the electrode arrays 32 and 36 to change the voltage of the power obtained from the electrical wall outlet. Such transformers are known to those of skill in the art therefore are not described here in detail.

The device 10 features control mechanisms for activating and deactivating the light source 14 and electrocution grid 26. While removal of the prongs 22 from an electrical outlet will obviously deactivate both components (unless otherwise connected to an alternate power source), the controls allow the grid 26 to be deactivated without deactivating the light source 14. A photoelectric sensor 44 provided on the protruding portion 20 of the housing 12 is connected between the prongs 22 and the light socket 30 and grid 26 to control the supply of power thereto. Sensing a lack of light in the surrounding environment, the sensor 44 allows electricity to flow to activate the bulb 28 and grid 26. When the sensor 44 detects that the surrounding environment is substantially light, indicating that illumination is not necessary, the flow of electricity is prevented to deactivate the bulb 28 and grid in order to eliminate wasteful energy use. The sensor 44 is mounted on the front of the protruding portion 20 so that light emitted from the bulb 28 disposed beneath that portion does not directly shine on the sensor 44. It should be appreciated that the sensor 44 may be connected between the prongs 22 and light socket 30 only in order to allow use of grid 26 regardless of the on or off state of the bulb 28. Alternatively, a conventional manually operated switch may be provided to turn the bulb 28 on and off as desired.

A switch 46 is connected between the prongs 22 through which power is supplied and the electrocution grid 26 to selectively control its operation. Being able to turn off the grid 26 allows the device 10 to be used solely as a night light, for example during cold winter conditions where the insect population is less significant. The switch 46 is of a conventional type that opens or closes the connection between the electrical connectors 16 and the electrode arrays 32 and 36 depending on its position, thereby preventing or allowing the flow of electricity respectively.

In addition to the switch 46 provided on the protruding portion 20 of the housing 12, the device 10 also features a safety switch 48 disposed on the mounting portion 18. Similar to the manually operated switch 46, the safety switch 48 is connected between the prongs 22 and grid 26 to interrupt or allow the flow of electricity from the power supply. In an off position shown in FIG. 5, the safety switch 48 extends forward from the mounting portion 18 and power flow is prevented from reaching the grid electrode arrays 32 and 36. Installation of the guard 24 of the device pushes the safety switch 48 into the mounting portion 18 to an on position in which the switch is considered closed and allows electricity to flow through it. This arrangement causes the grid 26 to be automatically deactivated when the guard 24 is removed so that accidental electrocution cannot occur. This way, if a user forgets to turn of the manual switch 46 when, for example, changing the light bulb 28, he or she will not be shocked if contact is made with the grid 26.

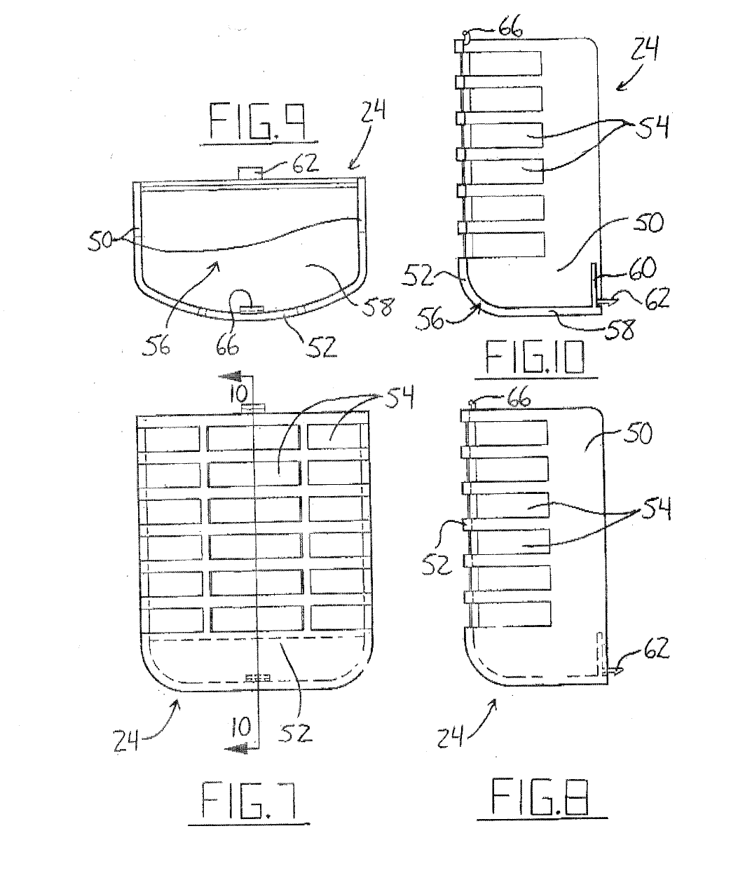

FIGS. 7 to 10 shows the guard 24 of the illumination and insect extermination device 10. The guard 24 features two side walls 50 connected by a front wall 52. When mounted on the housing 12 as shown in FIGS. 1 to 3, the side walls 50 extend forward from the mounting portion 18 and the front wall 52 extends across the device 10 in front of the bulb 28 and electrocution grid 26 such that they are enclosed between the housing 12 and guard 24. The guard 24 is open at the top, as the protruding portion 20 of the housing 12 blocks access from above the device 10. The walls 50 and 52 are perforated by openings 54 that are of a size that allows entry to the region between the housing 12 and guard 24 by small insects, but prevents entry by larger bodies, for example the fingers of a child. These openings 54 are closely spaced to allow significant portion of the light emitted by the bulb 28 to pass through them in order to attract insects and provide illumination. The arrangement of these openings 54 and the positioning of the grid 26 behind the bulb 28 form a balance between illumination and safety characteristics of the device 10. For example, placement of any portion of the grid 26 between the bulb 28 and the guard would further obstruct the passage of light therethrough, reducing the effectiveness of the device as an illumination source, while not including a guard 24 would present a possible voltage hazard. The guard 24 is made of translucent material so as not to restrict the passage of light therethrough to the openings 54.

The bottom of the guard 24 forms a receptacle 56 for catching insects that fall from the grid 26 after being electrocuted. The receptacle 56 is closed on all sides except for the top in order to contain the insects. The closed sides are defined by the front wall 52 and side walls 50 of the guard 24, a bottom wall or surface 58 and a rear wall 60. The rear wall 60 extends upward from the bottom 58 toward, but not reaching, the grid 26. Contact between this rear wall 60 and the safety switch 48 mounted on the mounting portion 18 of the housing 12 below the grid 26 holds the safety switch in the on position when the guard is installed. This activates the grid, unless the grid 26 has been deactivated by the manual switch 46. A notched tab 62 provided near the bottom of the guard and extending rearward therefrom is engaged in a receiving hole 64 of the mounting portion 18 to removably secure the guard on the housing 12. The guard 24 is further secured by another tab 66 extending upward from the front wall 52 to engage the protruding portion 20 of the housing 12. It should be appreciated that the guard 24 and insect receptacle 56 do not have to be integral and may be provided as separate components.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A device for illumination and insect extermination for use with a conventional electrical wall outlet, said device comprising:
a housing;
electrical connectors extending outward from the housing and adapted to mate with a typical electrical wall outlet;
a light source supported on the housing and operatively connected to the electrical connectors; and
an insect electrocution grid supported on the housing and operatively connected to the electrical connectors.

2. The device according to claim 1 wherein the insect electrocution grid is disposed between the electrical connectors and the light source in a horizontal direction.

3. The device according to claim 1 wherein the insect electrocution grid is disposed in a generally vertical plane, the electrical connectors and the light source being on opposite sides of said vertical plane.

4. The device according to claim 1 wherein the insect electrocution grid is arranged to leave at least one side of the light source open so as not to interfere with transmission of the light to said at least one side.

5. The device according to claim 1 further comprising a switch connected between the electrical connectors and the light source for selectively preventing and allowing transmission of power from said electrical connectors to said light source, wherein the switch is a photoelectric sensor for preventing and allowing the transmission of power to the light source during light and dark states respectively of an environment surrounding the device.

6. The device according to claim 1 further comprising a switch connected between the electrical connectors and the insect electrocution grid for selectively preventing and allowing transmission of power from said electrical connectors to said grid, wherein the switch is independent of the light source such that the transmission of power to said grid can be prevented without preventing transmission of power to said light source.

7. The device according to claim 6 wherein the switch is further connected to the insect electrocution grid for selectively preventing and allowing the transmission of power to both the light source and said grid.

8. The device according to claim 7 wherein the switch is a photoelectric sensor for preventing and allowing the transmission of power during light and dark states respectively of an environment surrounding the device.

9. The device according to claim 1 further comprising a transformer connected between the electrical connectors and the insect electrocution grid to change a voltage of power supplied from said electrical connectors to said grid.

10. The device according to claim 1 further comprising a guard detachably mounted on the housing for restricting access to the insect electrocution grid.

11. The device according to claim 10 further comprising a switch connected between the electrical connectors and the insect electrocution grid for selectively preventing and allowing transmission of power from said electrical connectors to said grid, said switch being disposed between the guard and the housing such that mounting said guard on said housing actuates said switch to allow said transmission of power.

12. The device according to claim 1 further comprising a guard mounted on the housing for restricting access to the insect electrocution grid wherein the guard is perforated to allow the insects to pass therethrough while preventing access by larger bodies.

13. The device according to claim 1 further comprising a guard mounted on the housing for restricting access to the insect electrocution grid wherein the guard comprises a catching portion disposed beneath said electrocution grid to catch insects having been electrocuted thereby, wherein the catching portion of the guard comprises a receptacle being open at a top end and closed at a bottom end and sides.

14. The device according to claim 1 further comprising a catching element supported on the housing beneath the electrocution grid to catch insects having been electrocuted thereby.

15. The device according to claim 14 wherein the catching element comprises a receptacle being open at a top end and closed at a bottom end and sides.

16. The device according to claim 1 wherein the light source comprises a bulb socket operatively connected to the electrical connectors and a bulb removably received in said bulb socket.

17. The device according to claim 1 wherein the insect electrocution grid comprises two arrays of electrodes for receiving opposing electrical charges from the electrical connectors, a distance between electrodes of one of the arrays and electrodes of the other array preventing power supplied through said connectors from flowing between said arrays unless said distance is substantially filled by a body separate from said device.

18. The device according to claim 1 wherein the electrical connectors comprise a pair of prongs from which the light source and insect electrocution grid commonly receive power, said prongs extending outward from the housing for insertion into the conventional electrical wall outlet.

19. The device according to claim 1 wherein the housing comprises a mounting portion from which the electrical connectors extend, said mounting portion adapted to sit generally flush against the conventional electrical wall outlet with which said connectors are adapted to mate, the light source and insect electrocution grid supported on a side of the mounting portion opposite said connectors.

20. The device according to claim 19 wherein the housing further comprises a protruding portion extending to the side of the mounting portion opposite the electrical connectors, the light source being supported by said protruding portion.
